(19) United States
(12) Patent Application Publication
(10) Pub. No.: US 2025/0191464 A1
(43) Pub. Date: Jun. 12, 2025

(54) LANE CHANGE DETECTION APPARATUS, LANE CHANGE DETECTION METHOD, AND NON-TRANSITORY COMPUTER-READABLE MEDIUM

(71) Applicant: NEC Corporation, Tokyo (JP)

(72) Inventors: Daisuke IKEFUJI, Tokyo (JP); Hemant Shivsagar PRASAD, Tokyo (JP); Sakiko MISHIMA, Tokyo (JP)

(73) Assignee: NEC Corporation, Tokyo (JP)

(21) Appl. No.: 18/959,724

(22) Filed: Nov. 26, 2024

(30) Foreign Application Priority Data
Dec. 12, 2023 (JP) 2023-209723

(51) Int. Cl. G08G 1/01; G01S 15/89; G08G 1/04

(52) U.S. Cl. CPC G08G 1/0129; G01S 15/895; G01S 15/8977; G08G 1/0116; G08G 1/04

(57) ABSTRACT

A lane change detection apparatus according to the present disclosure includes: at least one memory storing instructions; and at least one processor configured to execute the instructions to acquire, from a sensing apparatus configured to measure vibration generated on a road by using an optical fiber embedded in the road, vehicle vibration data indicating vibration generated by traveling of a vehicle on the road, and detect whether there is a lane change of the vehicle, based on a specific feature of a current frame of the vehicle vibration and a traveling lane in which the vehicle has traveled in a previous frame of the vehicle vibration.

### INCORPORATION BY REFERENCE

This application is based upon and claims the benefit of priority from Japanese patent application No. 2023-209723, filed on Dec. 12, 2023, the disclosure of which is incorporated herein in its entirety by reference.

### TECHNICAL FIELD

The present disclosure relates to a lane change detection apparatus, a lane change detection method, and a non-transitory computer-readable medium.

### BACKGROUND ART

A sensing apparatus connected to an optical fiber embedded in a road can measure vehicle vibration of a vehicle traveling on the road over an entire section in which the optical fiber is embedded, by optical fiber sensing using the optical fiber as a line sensor. Further, the sensing apparatus can visualize a trajectory of the vehicle by generating a visualized image representing measured intensity of the vehicle vibration as a graph of time and distance of the optical fiber from the sensing apparatus. Further, by using an existing optical fiber for communication as the optical fiber, it is possible to introduce a system for monitoring a vehicle at low cost. A system for monitoring a vehicle by optical fiber sensing is disclosed in Published Japanese Translation of PCT International Publication for Patent Application, No. 2023-511875 and International Patent Publication No. WO 2020/116030, for example.

### SUMMARY

Incidentally, in order to recognize a vehicle traveling on a road by optical fiber sensing, it is necessary to recognize a lane change of the vehicle.

However, in the techniques disclosed in Published Japanese Translation of PCT International Publication for Patent Application, No. 2023-511875 and International Patent Publication No. WO 2020/116030, there is a problem that a lane change of a vehicle traveling on a road cannot be detected.

In view of the problem described above, an example object of the present disclosure is to provide a lane change detection apparatus, a lane change detection method, and a non-transitory computer-readable medium that make it possible to detect a lane change of a vehicle traveling on a road.

In a first example aspect, a lane change detection apparatus includes:
at least one memory storing instructions; and
at least one processor configured to execute the instructions to
   acquire, from a sensing apparatus configured to measure vibration generated on a road by using an optical fiber embedded in the road, vehicle vibration data indicating vibration generated by traveling of a vehicle on the road, and
   detect whether there is a lane change of the vehicle, based on a specific feature in a current frame of the vehicle vibration and a traveling lane in which the vehicle has traveled in a previous frame of the vehicle vibration.

In a second example aspect, a lane change detection method is a lane change detection method to be performed by a lane change detection apparatus, and includes:
acquiring, from a sensing apparatus configured to measure vibration generated on a road by using an optical fiber embedded in the road, vehicle vibration data indicating vibration generated by traveling of a vehicle on the road; and
detecting whether there is a lane change of the vehicle, based on a specific feature in a current frame of the vehicle vibration and a traveling lane in which the vehicle has traveled in a previous frame of the vehicle vibration.

In a third example aspect, a non-transitory computer-readable medium is a non-transitory computer-readable medium storing a program causing a computer to execute:
a procedure of acquiring, from a sensing apparatus configured to measure vibration generated on a road by using an optical fiber embedded in the road, vehicle vibration data indicating vibration generated by traveling of a vehicle on the road; and
a procedure of detecting whether there is a lane change of the vehicle, based on a specific feature in a current frame of the vehicle vibration and a traveling lane in which the vehicle has traveled in a previous frame of the vehicle vibration.

An example advantage according to the above-described aspects is that it is possible to provide a lane change detection apparatus, a lane change detection method, and a non-transitory computer-readable medium that make it possible to detect a lane change of a vehicle traveling on a road.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating an arrangement example of an optical fiber and a sensing apparatus;

FIG. 2 is a diagram illustrating an example of a visualized image to be generated by the sensing apparatus;

FIG. 3 illustrates an example of vehicle vibration data of a vehicle to be generated by the sensing apparatus;

FIG. 4 is a diagram illustrating a schematic configuration example of a lane change detection system according to the present disclosure;

FIG. 5 is a flowchart illustrating an example of a schematic operation flow of the lane change detection system according to the present disclosure;

FIG. 6 is a diagram illustrating a schematic configuration example of the lane change detection system according to the present disclosure;

FIG. 7 is a flow chart illustrating an example of a schematic operation flow of the lane change detection system according to the present disclosure;

FIG. 8 is a diagram illustrating a schematic configuration example of the lane change detection system according to the present disclosure;

FIG. 9 is a diagram illustrating an example of frequency spectrum features when a vehicle is traveling in a first lane and when the vehicle is traveling in a second lane;

FIG. 10 is a flow chart illustrating an example of a schematic operation flow of the lane change detection system according to the present disclosure;

FIG. 11 is a diagram illustrating a schematic configuration example of the lane change detection system according to the present disclosure;

FIG. 12 is a diagram illustrating an example of spectral centroids of frequency spectrums when the vehicle is traveling in the first lane and when the vehicle is traveling in the second lane;

FIG. 13 is a flow chart illustrating an example of a schematic operation flow of the lane change detection system according to the present disclosure;

FIG. 14 is a diagram illustrating a schematic configuration example of the lane change detection system according to the present disclosure;

FIG. 15 is a flow chart illustrating an example of a schematic operation flow of the lane change detection system according to the present disclosure;

FIG. 16 is a flow chart illustrating an example of a schematic operation flow of the lane change detection system according to the present disclosure;

FIG. 17 is a flow chart illustrating an example of a schematic operation flow of the lane change detection system according to the present disclosure;

FIG. 18 is a diagram illustrating a schematic configuration example of the lane change detection system according to the present disclosure;

FIG. 19 is a diagram illustrating an example of a lane change of a vehicle in a case where there is a fallen object or the like on a road;

FIG. 20 is a flow chart illustrating an example of a schematic operation flow of the lane change detection system according to the present disclosure;

FIG. 21 is a diagram illustrating a schematic configuration example of the lane change detection system according to the present disclosure; and

FIG. 22 is a block diagram illustrating a hardware configuration example of a computer that achieves a lane change detection apparatus according to the present disclosure.

### EXAMPLE EMBODIMENT

Hereinafter, example embodiments of the present disclosure is described with reference to the drawings. Note that the following description and the drawings are omitted and simplified as appropriate for clarity of description. In the following drawings, the same elements are denoted by the same reference numerals, and redundant descriptions are omitted as necessary. Further, specific numerical values and the like described below are merely examples for facilitating understanding of the present disclosure, and are not limited thereto.

<Sensing Apparatus being Used in the Present Disclosure>

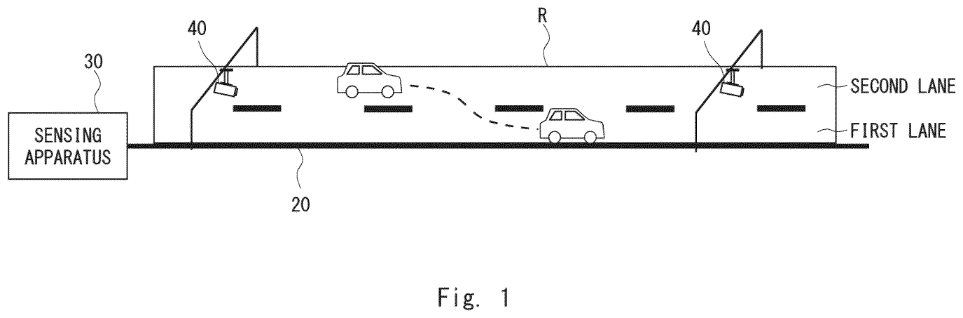

Before describing each example embodiment of the present disclosure, a sensing apparatus 30 being a data supplier used in each example embodiment is described with reference to FIG. 1.

As illustrated in FIG. 1, the sensing apparatus 30 is connected to an optical fiber 20 embedded in a road R, and measures vibration generated on the road R by optical fiber sensing using the optical fiber 20. For example, the sensing apparatus 30 is achieved by a distributed fiber optic sensing (DFOS) apparatus or the like.

In the example embodiments described below, it is assumed that the optical fiber 20 is buried along the road R under the road shoulder or the median strip of the road R. Further, the road R is a road with two lanes, and a lane closer to the optical fiber 20 among the two lanes is referred to as a first lane, and a lane farther from the optical fiber 20 is referred to as a second lane. In FIG. 1, a camera 40 that captures an image of a road R is installed on the road R, but the presence or absence of the camera 40 is optional.

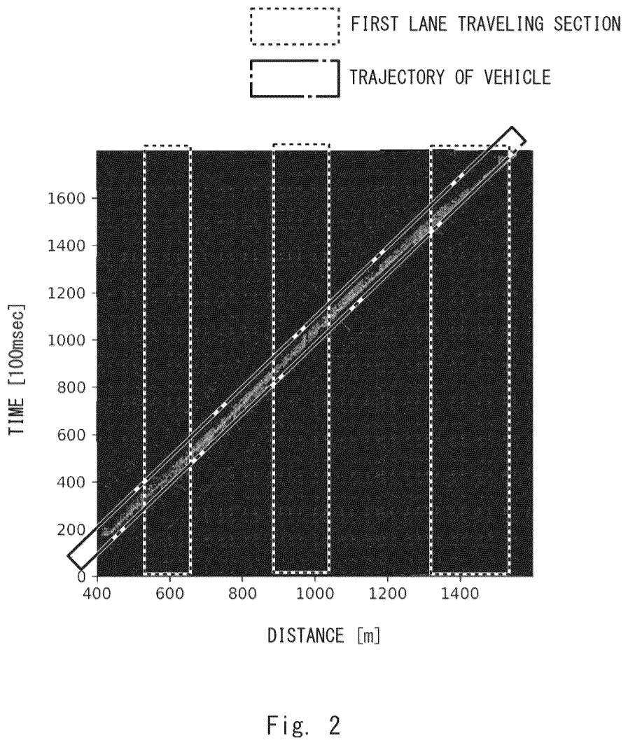

As described above, the sensing apparatus 30 is able to visualize a trajectory of a vehicle by generating a visualized image representing intensity of the vehicle vibration measured by optical fiber sensing as a graph displaying the distance of the optical fiber 20 from the sensing apparatus 30 and time. FIG. 2 illustrates an example of a visualized image generated by the sensing apparatus 30. In FIG. 2, the horizontal axis represents the distance of the optical fiber 20 from the sensing apparatus 30, and the vertical axis represents time.

In the visualized image illustrated in FIG. 2, when a vehicle is traveling on the road R, the traveling of the vehicle is represented by a line. For example, one vehicle traveling on the road R is represented by one oblique line. The inclination of the oblique line represents the traveling speed of the vehicle, and the smaller the inclination of the oblique line, the higher the traveling speed of the vehicle.

In the visualized image illustrated in FIG. 2, one oblique line indicating a trajectory of one vehicle traveling on the road R is surrounded by a dashed-dotted line. In the visualized image illustrated in FIG. 2, the one oblique line is highlighted by masking the entire area excluding the one oblique line. Further, in the visualized image illustrated in FIG. 2, a section in which it is confirmed that the vehicle is traveling in the first lane by the camera 40 or the like is surrounded by a dotted line.

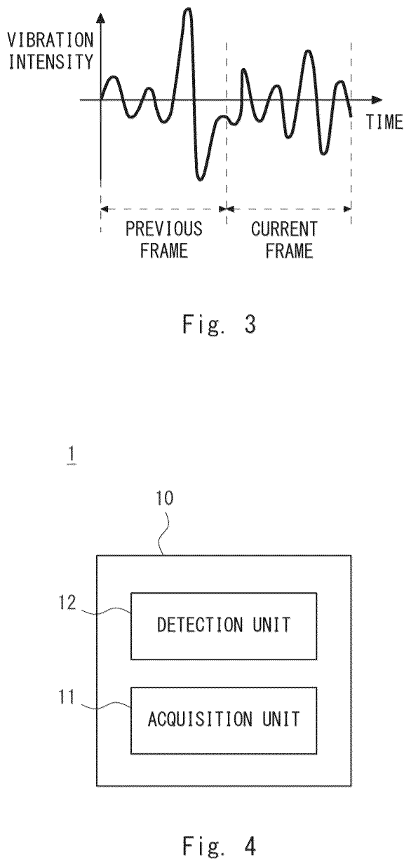

In addition, the sensing apparatus 30 is able to individually track a vehicle the trajectory of which appears as an oblique line in the visualized image. FIG. 3 illustrates an example of vehicle vibration data generated by the sensing apparatus 30 and indicating vibration generated by traveling of the vehicle on the road R. FIG. 3 illustrates an example of vehicle vibration generated at any position (distance of the optical fiber 20 from the sensing apparatus 30) on the road R, where the horizontal axis represents time and the vertical axis represents vibration intensity.

In each of the example embodiments described below, data as illustrated in FIG. 3 is acquired from the sensing apparatus 30 as the vehicle vibration data of the vehicle traveling on the road R, and whether there is a lane change of the vehicle is detected using the acquired data.

Hereinafter, example embodiments are described.

### First Example Embodiment

First, a schematic configuration example of a lane change detection system 1 is described with reference to FIG. 4.

The lane change detection system 1 includes a lane change detection apparatus 10.

The lane change detection apparatus 10 includes an acquisition unit 11 and a detection unit 12.

The acquisition unit 11 acquires, from the sensing apparatus 30, data as illustrated in FIG. 3 as vehicle vibration data of a vehicle traveling on the road R. At this time, the acquisition unit 11 also acquires, from the sensing apparatus 30, the position (the distance of the optical fiber 20 from the sensing apparatus 30) where the vehicle vibration is generated.

The detection unit 12 detects whether there is a lane change of the vehicle by using the vehicle vibration data of the vehicle acquired by the acquisition unit 11.

Herein, when the vehicle changes lanes, the distance from the optical fiber 20 to the vehicle changes, and accordingly, the features of the vehicle vibration of the vehicle also change. The features of the vehicle vibration that change according to the lane change are, for example, vibration intensity, frequency spectrum features, and the like.

Therefore, it is possible to detect whether there is a lane change of the vehicle by referring to whether the features of the vehicle vibration of the vehicle have changed.

The features of the vehicle vibration when the vehicle is traveling in each lane (a first lane and a second lane) are different from each other, and may be recognized in advance.

Therefore, from a traveling lane in which the vehicle was traveling immediately before, it is possible to recognize the features of the vehicle vibration immediately before of the vehicle.

As described above, it is possible to determine whether the features of the vehicle vibration of the vehicle have changed by using the features of the vehicle vibration at the present time and a traveling lane in which the vehicle was traveling immediately before, and thus it is possible to detect whether the lane change of the vehicle occurred.

Therefore, the detection unit 12 divides the vehicle vibration data of the vehicle acquired by the acquisition unit 11 in units of frames, and detects whether there is the lane change of the vehicle, based on a specific feature of a current frame of the vehicle vibration and a traveling lane in which the vehicle was traveling in a previous frame of the vehicle vibration.

Note that it is assumed that the detection unit 12 recognizes in advance the traveling lane in which the vehicle was traveling in the previous frame by any method. For example, as illustrated in FIG. 1, in a case where the camera 40 is installed on the road R, the detection unit 12 may determine the traveling lane of the previous frame by using the image captured by the camera 40.

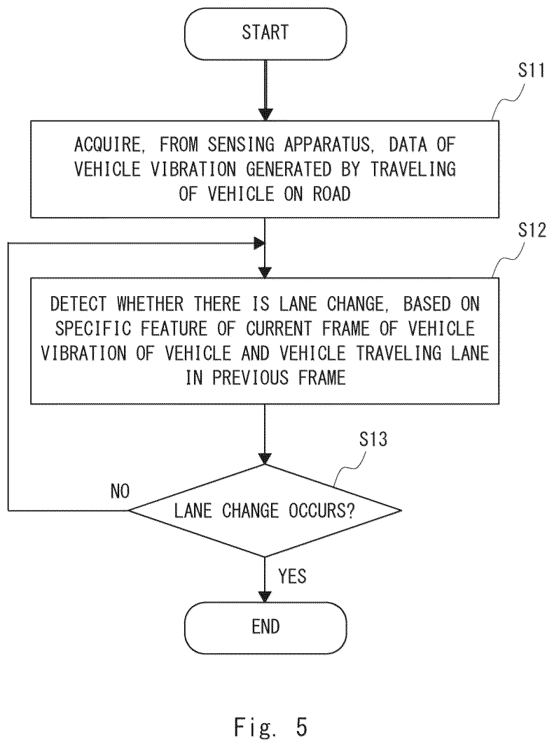

Next, a schematic operation example of the lane change detection system 1 is described with reference to FIG. 5.

The acquisition unit 11 acquires, from the sensing apparatus 30, data of vehicle vibration generated by traveling of the vehicle on the road R (step S11).

The detection unit 12 detects whether there is a lane change of the vehicle, based on the specific feature of the current frame of the vehicle vibration of the vehicle acquired by the acquisition unit 11 and a traveling lane in which the vehicle was traveling in the previous frame of the vehicle vibration (step S12).

When it is determined that the lane change of the vehicle has not occurred (NO in step S13), the detection unit 12 returns to step S12, and when it is determined that the lane change of the vehicle has occurred (YES in step S13), the processing ends. In the case where the process returns to step S12, the detection unit 12 sets the current frame and the next frame of the vehicle vibration of the vehicle as the previous frame and the current frame, and then performs the processing of step S12.

As described above, according to the first example embodiment, the acquisition unit 11 acquires, from the sensing apparatus 30, the data of the vehicle vibration generated by the traveling of the vehicle on the road R. The detection unit 12 detects whether there is a lane change of the vehicle, based on a specific feature in the current frame of the vehicle vibration of the vehicle and a traveling lane in which the vehicle was traveling in the previous frame of the vehicle vibration.

Accordingly, it is possible to detect a lane change of the vehicle traveling on the road R.

In addition, since the lane change of the vehicle can be detected, a lane in which the vehicle is traveling after the lane change may also be detected. Therefore, it is possible to continuously detect the lane in which the vehicle is traveling by detecting the lane change of the lane thereafter. As a result, a vehicle detection function performed by an existing traffic counter or the like can be performed at any position on the road R in which the optical fiber 20 is embedded.

Note that the detection unit 12 may calculate average vibration intensity as a specific feature in the current frame of the vehicle vibration of the vehicle. The detection unit 12 may detect whether there is a lane change of the vehicle, based on a traveling lane in which the vehicle was traveling in the previous frame of the vehicle vibration and a comparison result between the average vibration intensity in the current frame of the vehicle vibration and a threshold value.

Alternatively, the detection unit 12 may calculate average vibration intensity of a specific frequency band as a specific feature in the current frame of the vehicle vibration of the vehicle. The detection unit 12 may detect whether there is a lane change of the vehicle, based on the traveling lane in which the vehicle was traveling in the previous frame of the vehicle vibration and a comparison result between the average vibration intensity of the specific frequency band in the current frame of the vehicle vibration and a threshold value. In such a case, the specific frequency band may be a band in which a difference between average vibration intensity of the vehicle vibration before the lane change of the vehicle (average vibration intensity of the vehicle vibration when traveling in the first lane (or the second lane)) and average vibration intensity of the vehicle vibration after the lane change of the vehicle (average vibration intensity of the vehicle vibration when traveling in the second lane (or the first lane)) is equal to or greater than a predetermined value.

Alternatively, the detection unit 12 may calculate a spectral centroid of a frequency spectrum as a specific feature in the current frame of the vehicle vibration of the vehicle. Then, the detection unit 12 may calculate a centroid shift amount, which is a difference between a spectral centroid of the current frame of the vehicle vibration and a spectral centroid of the previous frame of the vehicle vibration. The detection unit 12 may detect whether there is a lane change of the vehicle, based on a traveling lane in which the vehicle was traveling in the previous frame of the vehicle vibration and a comparison result between the centroid shift amount of the current frame of the vehicle vibration and a threshold value.

Alternatively, the detection unit 12 may be provided with a learning model that is trained, with a feature amount when the lane change of the vehicle occurred, in advance. Then, the detection unit 12 may input, to the learning model, a specific feature in the current frame of the vehicle vibration of the vehicle and a traveling lane in which the vehicle was traveling in the previous frame of the vehicle vibration as a feature amount, and detect whether there is a lane change of the vehicle, based on the output of the learning model.

Further, the lane change detection apparatus 10 may further include a determination unit that, when the detection unit 12 determines that a lane change of the vehicle has occurred, determines a position at which the lane change of the vehicle has occurred on the road R, and in a case where a lane change has occurred a predetermined number of times or more at the position, determines the position as an abnormality occurrence position.

### Second Example Embodiment

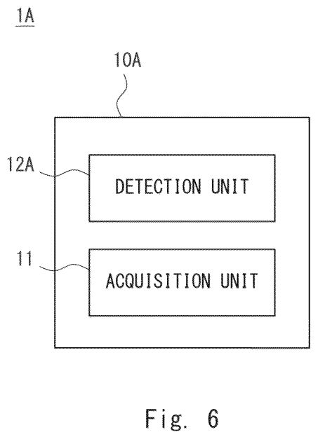

First, a schematic configuration example of a lane change detection system 1A is described with reference to FIG. 6.

The lane change detection system 1A includes a lane change detection apparatus 10A.

As compared with the lane change detection apparatus 10, the lane change detection apparatus 10A has a configuration in which the detection unit 12 is replaced with a detection unit 12A.

As described above, an acquisition unit 11 acquires, from a sensing apparatus 30, data as illustrated in FIG. 3 as vehicle vibration data of a vehicle traveling on a road R.

However, the vehicle vibration data of the vehicle acquired by the acquisition unit 11 varies in instantaneous vibration intensity.

Therefore, the detection unit 12A utilizes average vibration intensity of the frame. Thus, the lane change detection accuracy may be stabilized.

That is, the detection unit 12A calculates average vibration intensity as a specific feature in the current frame of the vehicle vibration of the vehicle.

Further, the detection unit 12A detects whether there is a lane change of the vehicle, based on a traveling lane in which the vehicle was traveling in the previous frame of the vehicle vibration and a comparison result between the average vibration intensity in the current frame of the vehicle vibration and the threshold value.

Note that it is assumed that the detection unit 12A sets the above-described threshold value in advance by performing pre-measurement or the like. Further, it is assumed that the detection unit 12A recognizes the traveling lane in which the vehicle was traveling in the previous frame in advance by any method (for example, a method using an image captured by the camera 40 installed on the road R).

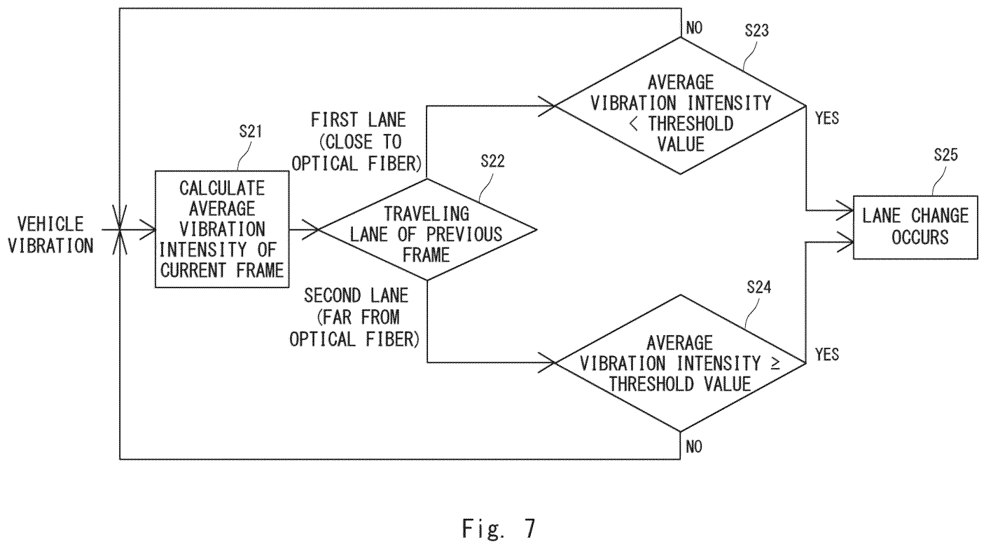

Next, a schematic operation example of the lane change detection system 1A is described with reference to FIG. 7.

When the vehicle vibration data of the vehicle traveling on the road R is acquired from the sensing apparatus 30 by the acquisition unit 11, the detection unit 12A calculates the average vibration intensity in the current frame of the vehicle vibration of the vehicle (step S21).

Then, the detection unit 12A determines whether the traveling lane in which the vehicle was traveling in the previous frame of the vehicle vibration is the first lane or the second lane (step S22).

When the traveling lane of the previous frame is the first lane being closer to the optical fiber 20, the detection unit 12A determines whether the average vibration intensity is less than the threshold value (step S23). When the average vibration intensity is less than the threshold value (YES in step S23), the detection unit 12A determines that the lane change of the vehicle has occurred (step S25). Meanwhile, when the average vibration intensity is not less than the threshold value (NO in step S23), the detection unit 12A returns to step S21.

When the traveling lane of the previous frame is the second lane being farther from the optical fiber 20, the detection unit 12A determines whether the average vibration intensity is equal to or greater than the threshold value (step S24). When the average vibration intensity is equal to or greater than the threshold value (YES in step S24), the detection unit 12A determines that the lane change of the vehicle has occurred (step S25). Meanwhile, when the average vibration intensity is not equal to or greater than the threshold value (NO in step S24), the detection unit 12A returns to step S21.

When the process returns to step S21, the detection unit 12A sets the current frame and the next frame of the vehicle vibration of the vehicle as the previous frame and the current frame, and then performs the processing of step S21.

As described above, according to the second example embodiment, the detection unit 12A calculates the average vibration intensity of the current frame of the vehicle vibration of the vehicle, and detects whether there is the lane change of the vehicle, based on the traveling lane in which the vehicle was traveling in the previous frame of the vehicle vibration and the comparison result between the average vibration intensity in the current frame of the vehicle vibration and the threshold value. Accordingly, it is possible to detect a lane change of the vehicle traveling on the road R. Other effects are similar to those of the first example embodiment described above.

### Third Example Embodiment

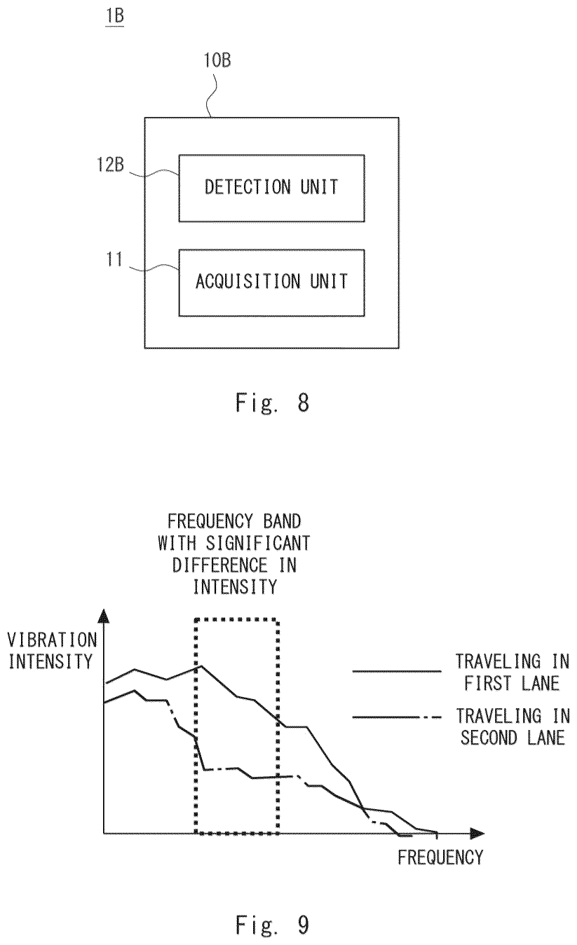

First, a schematic configuration example of a lane change detection system 1B is described with reference to FIG. 8.

The lane change detection system 1B includes a lane change detection apparatus 10B.

As compared with the lane change detection apparatus 10, the lane change detection apparatus 10B has a configuration in which the detection unit 12 is replaced with a detection unit 12B.

As described above, an acquisition unit 11 acquires, from a sensing apparatus 30, data as illustrated in FIG. 3 as vehicle vibration data of a vehicle traveling on the road R.

However, the data of the vehicle vibration of the vehicle acquired by the acquisition unit 11 varies in instantaneous vibration intensity.

Therefore, the detection unit 12B utilizes average vibration intensity of the frame. Thus, the lane change detection accuracy may be stabilized.

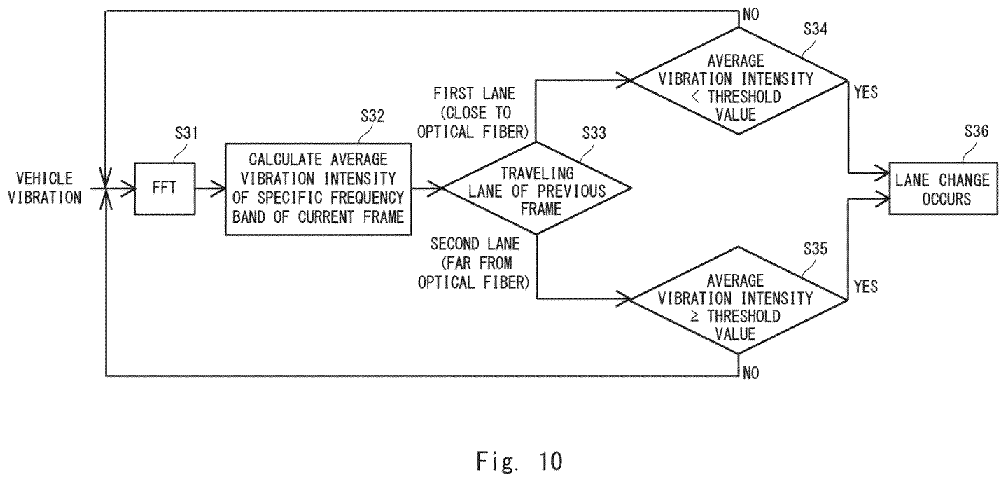

Further, referring to FIG. 9, frequency spectrum features acquired by performing fast Fourier transform (FFT) on data of the vehicle vibration when the vehicle is traveling in the first lane and frequency spectrum features acquired by performing FFT on data of the vehicle vibration when the vehicle is traveling in the second lane are illustrated. As can be seen from FIG. 9, there is a frequency band in which there is a significant difference in vibration intensity between when the vehicle is traveling in the first lane and when the vehicle is traveling in the second lane.

Therefore, the detection unit 12B acquires, in advance, a frequency band in which the difference between the average vibration intensity of the vehicle vibration when the vehicle is traveling in the first lane and the average vibration intensity of the vehicle vibration when the vehicle is traveling in the second lane is equal to or greater than a predetermined value, as a specific frequency band.

Then, the detection unit 12B utilizes the average vibration intensity of the specific frequency band in the frame. Accordingly, it is possible to further stabilize the lane change detection accuracy.

That is, the detection unit 12B calculates the average vibration intensity of the specific frequency band as a specific feature in the current frame of the vehicle vibration.

Further, the detection unit 12B detects whether there is a lane change of the vehicle, based on the traveling lane in which the vehicle was traveling in the previous frame of the vehicle vibration and the comparison result between the average vibration intensity of the specific frequency band in the current frame of the vehicle vibration and the threshold value.

Note that it is assumed that the detection unit 12B sets the above-described threshold value in advance by performing pre-measurement or the like. Further, it is assumed that the detection unit 12B recognizes the traveling lane in which the vehicle was traveling in the previous frame in advance by any method (for example, a method using an image captured by the camera 40 installed on the road R).

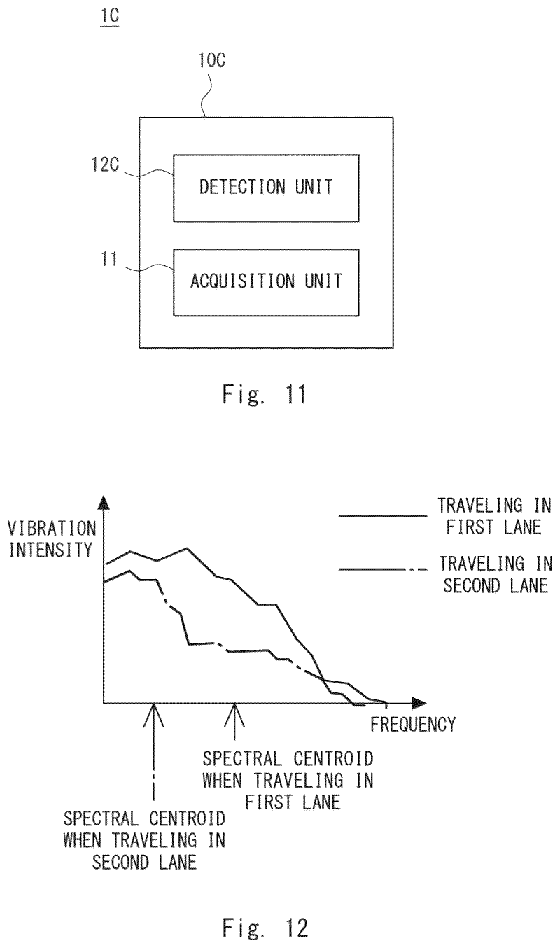

Next, a schematic operation example of the lane change detection system 1B is described with reference to FIG. 10.

When the vehicle vibration data of the vehicle traveling on the road R is acquired from the sensing apparatus 30 by the acquisition unit 11, the detection unit 12B performs FFT on the current frame-portion of the vehicle vibration of the vehicle (step S31), and calculates the average vibration intensity of the specific frequency band of the current frame (step S32).

Next, the detection unit 12B determines whether the traveling lane in which the vehicle was traveling in the previous frame of the vehicle vibration is the first lane or the second lane (step S33).

When the traveling lane of the previous frame is the first lane being closer to the optical fiber 20, the detection unit 12B determines whether the average vibration intensity is less than the threshold value (step S34). When the average vibration intensity is less than the threshold value (YES in step S34), the detection unit 12B determines that the lane change of the vehicle has occurred (step S36). Meanwhile, when the average vibration intensity is not less than the threshold value (NO in step S34), the detection unit 12B returns to step S31.

When the traveling lane of the previous frame is the second lane being farther from the optical fiber 20, the detection unit 12B determines whether the average vibration intensity is equal to or greater than the threshold value (step S35). When the average vibration intensity is equal to or greater than the threshold value (YES in step S35), the detection unit 12B determines that the lane change of the vehicle has occurred (step S36). Meanwhile, when the average vibration intensity is not equal to or greater than the threshold value (NO in step S35), the detection unit 12B returns to step S31.

When the process returns to step S31, the detection unit 12B sets the current frame and the next frame of the vehicle vibration of the vehicle as the previous frame and the current frame, and then performs the processing of step S31.

As described above, according to the third example embodiment, the detection unit 12B calculates the average vibration intensity of the specific frequency band in the current frame of the vehicle vibration of the vehicle, and detects whether there is the lane change of the vehicle, based on the traveling lane in which the vehicle was traveling in the previous frame of the vehicle vibration and the comparison result between the average vibration intensity of the specific frequency band in the current frame of the vehicle vibration and the threshold value. Accordingly, it is possible to detect a lane change of the vehicle traveling on the road R. Other effects are similar to those of the first example embodiment described above.

### Fourth Example Embodiment

First, a schematic configuration example of a lane change detection system 1C is described with reference to FIG. 11.

The lane change detection system 1C includes a lane change detection apparatus 10C.

As compared with the lane change detection apparatus 10, the lane change detection apparatus 10C has a configuration in which the detection unit 12 is replaced with a detection unit 12C.

Referring to FIG. 12, frequency spectrum features acquired by performing FFT on the data of the vehicle vibration when the vehicle is traveling in the first lane and frequency spectrum features acquired by performing FFT on the data of the vehicle vibration when the vehicle is traveling in the second lane are illustrated. As can be seen from FIG. 12, the frequency spectrum features are different between when the vehicle is traveling in the first lane and when the vehicle is traveling in the second lane.

Therefore, the detection unit 12C utilizes a spectral centroid as an index representing the characteristic of the frequency spectrum features.

That is, the detection unit 12C calculates the spectral centroid of the frequency spectrum as a specific feature in the current frame of the vehicle vibration. Further, the detection unit 12C calculates a centroid shift amount, which is a difference between the spectral centroid of the current frame of the vehicle vibration and the spectral centroid of the previous frame of the vehicle vibration.

Further, the detection unit 12C detects whether there is a lane change of the vehicle, based on the traveling lane in which the vehicle was traveling in the previous frame of the vehicle vibration and the comparison result between the centroid shift amount of the current frame of the vehicle vibration and the threshold value.

Note that it is assumed that the detection unit 12C sets the above-described threshold value in advance by performing pre-measurement or the like. Further, it is assumed that the detection unit 12C recognizes the traveling lane in which the vehicle was traveling in the previous frame in advance by any method (for example, a method using an image captured by the camera 40 installed on the road R).

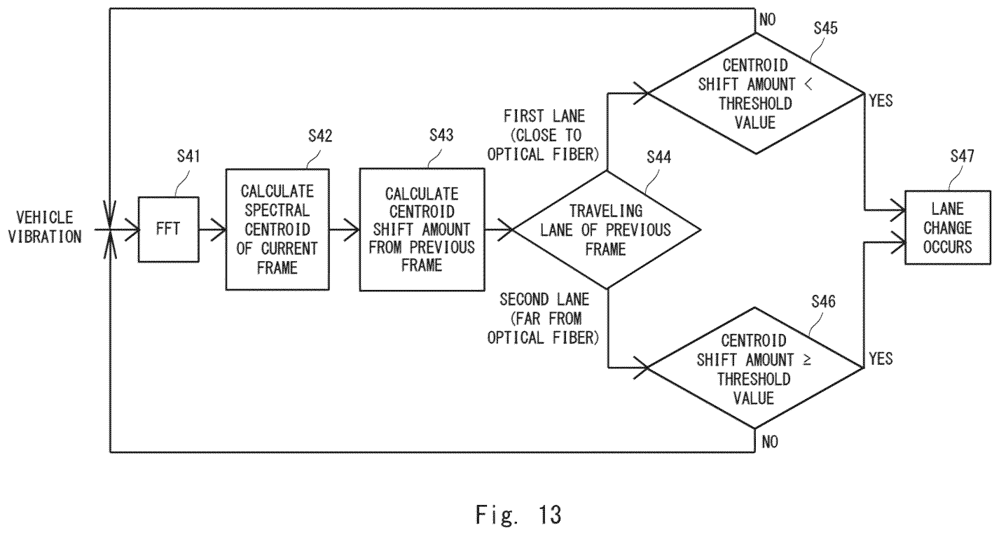

Next, a schematic operation example of the lane change detection system 1C is described with reference to FIG. 13.

When the vehicle vibration data of the vehicle traveling on the road R is acquired from the sensing apparatus 30 by the acquisition unit 11, the detection unit 12C performs FFT on the current frame-portion of the vehicle vibration of the vehicle (step S41), and calculates the spectral centroid of the frequency spectrum of the current frame of the vehicle vibration (step S42). Further, the detection unit 12C calculates a centroid shift amount, which is a difference between the spectrum centroid of the current frame of the vehicle vibration and the spectrum centroid of the previous frame of the vehicle vibration (step S43).

Next, the detection unit 12C determines whether the traveling lane in which the vehicle was traveling in the previous frame of the vehicle vibration is the first lane or the second lane (step S44).

When the traveling lane of the previous frame is the first lane being closer to the optical fiber 20, the detection unit 12C determines whether the centroid shift amount is less than the threshold value (step S45). When the centroid shift amount is less than the threshold value (YES in step S45), the detection unit 12C determines that the lane change of the vehicle has occurred (step S47). Meanwhile, when the centroid shift amount is not less than the threshold value (NO in step S45), the detection unit 12C returns to step S41.

When the traveling lane of the previous frame is the second lane being farther from the optical fiber 20, the detection unit 12C determines whether the centroid shift amount is equal to or greater than the threshold value (step S46). When the centroid shift amount is equal to or greater than the threshold value (YES in step S46), the detection unit 12C determines that the lane change of the vehicle has occurred (step S47). Meanwhile, when the centroid shift amount is not equal to or greater than the threshold value (NO in step S46), the detection unit 12C returns to step S41.

When the process returns to step S41, the detection unit 12C sets the current frame and the next frame of the vehicle vibration of the vehicle as the previous frame and the current frame, and then performs the processing of step S41.

As described above, according to the fourth example embodiment, the detection unit 12C calculates the spectral centroid of the frequency spectrum in the current frame of the vehicle vibration of the vehicle, and further calculates the centroid shift amount, which is the difference between the spectral centroid of the current frame of the vehicle vibration and the spectral centroid of the previous frame of the vehicle vibration. Then, the detection unit 12C detects whether there is a lane change of the vehicle, based on the traveling lane in which the vehicle was traveling in the previous frame of the vehicle vibration and the comparison result between the centroid shift amount in the current frame of the vehicle vibration and the threshold value. Accordingly, it is possible to detect a lane change of the vehicle traveling on the road R. Other effects are similar to those of the first example embodiment described above.

### Fifth Example Embodiment

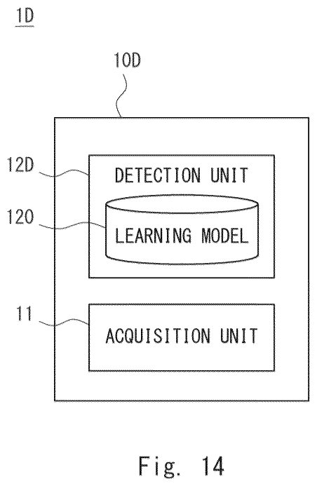

First, a schematic configuration example of the lane change detection system 1D is described with reference to FIG. 14.

The lane change detection system 1D includes a lane change detection apparatus 10D.

As compared with the lane change detection apparatus 10, the lane change detection apparatus 10D has a configuration in which the detection unit 12 is replaced with a detection unit 12D.

The detection unit 12D includes a learning model 120 that is trained, with a feature amount when the lane change of the vehicle occurs, in advance.

The feature amount with which the learning model 120 is trained includes at least a specific feature of the current frame of the vehicle vibration of the vehicle and a traveling lane in which the vehicle was traveling in the previous frame of the vehicle vibration.

Therefore, the detection unit 12D inputs, to the learning model 120, the specific feature of the current frame of the vehicle vibration of the vehicle and a traveling lane in which the vehicle was traveling in the previous frame of the vehicle vibration as feature amounts.

Then, the learning model 120 outputs, for example, a probability that a lane change of the vehicle has occurred, or the like. Therefore, the detection unit 12D detects whether there is a lane change of the vehicle, based on the output of the learning model 120.

Note that the feature amount with which the learning model 120 is trained may be added. For example, the learning model 120 may add a traveling speed, a vehicle type, and the like in addition to the traveling lane as the feature amount of the vehicle in the previous frame of the vehicle vibration. By adding the feature amounts, the lane change detection accuracy can be stabilized.

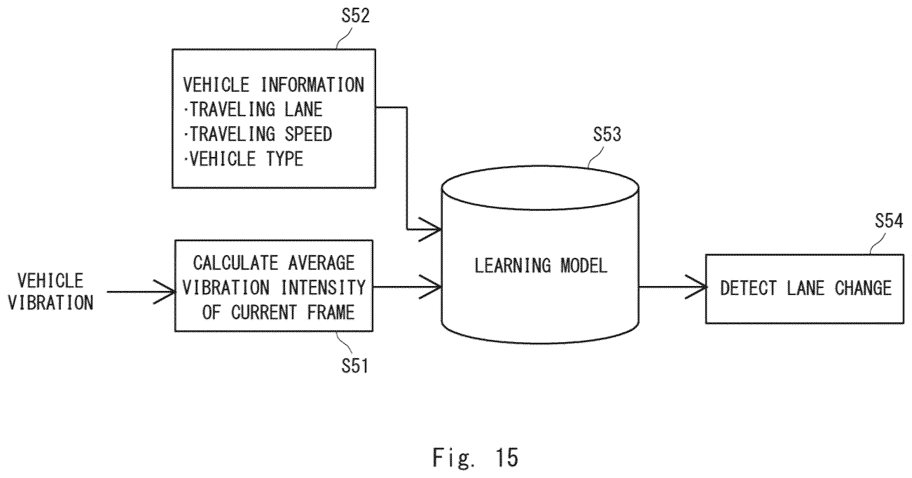

Next, a schematic operation example of the lane change detection system 1D is described with reference to FIGS. 15 to 17. In FIGS. 15 to 17, it is assumed that the learning model 120 is trained with the traveling lane, the traveling speed, and the vehicle type as the feature amount of the vehicle in the previous frame of the vehicle vibration.

First, with reference to FIG. 15, an operation example in a case where average vibration intensity is used as a specific feature in the current frame of the vehicle vibration is described, similarly to the second example embodiment described above.

When the vehicle vibration data of the vehicle traveling on the road R is acquired from the sensing apparatus 30 by the acquisition unit 11, the detection unit 12D calculates the average vibration intensity of the current frame of the vehicle vibration of the vehicle, and inputs the calculated average vibration intensity to the learning model 120 (step S51).

Further, the detection unit 12D inputs, to the learning model 120, the traveling lane, the traveling speed, and the vehicle type as the vehicle information relating to the vehicle at the time of the previous frame of the vehicle vibration (step S52).

Then, the learning model 120 outputs, for example, a probability that a lane change of the vehicle has occurred, or the like (step S53). Therefore, the detection unit 12D detects whether there is a lane change of the vehicle, based on the output of the learning model 120 (step S54).

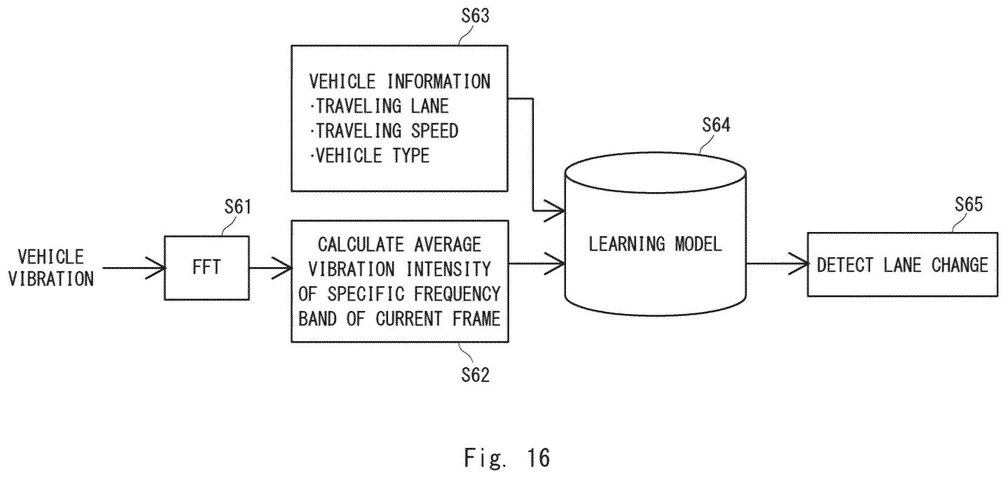

Next, with reference to FIG. 16, an operation example in a case where the average vibration intensity of a specific frequency band is utilized as a specific feature in the current frame of the vehicle vibration is described, similarly to the third example embodiment described above.

When the vehicle vibration data of the vehicle traveling on the road R is acquired from the sensing apparatus 30 by the acquisition unit 11, the detection unit 12D performs FFT on the current frame-portion of the vehicle vibration of the vehicle (step S61). Further, the detection unit 12D calculates the average vibration intensity of the specific frequency band in the current frame, and inputs the calculated average vibration intensity to the learning model 120 (step S62).

Further, the detection unit 12D inputs, to the learning model 120, the traveling lane, the traveling speed, and the vehicle type as the vehicle information relating to the vehicle at the time of the previous frame of the vehicle vibration (step S63).

Then, the learning model 120 outputs, for example, a probability that a lane change of the vehicle has occurred, or the like (step S64). Therefore, the detection unit 12D detects whether there is a lane change of the vehicle, based on the output of the learning model 120 (step S65).

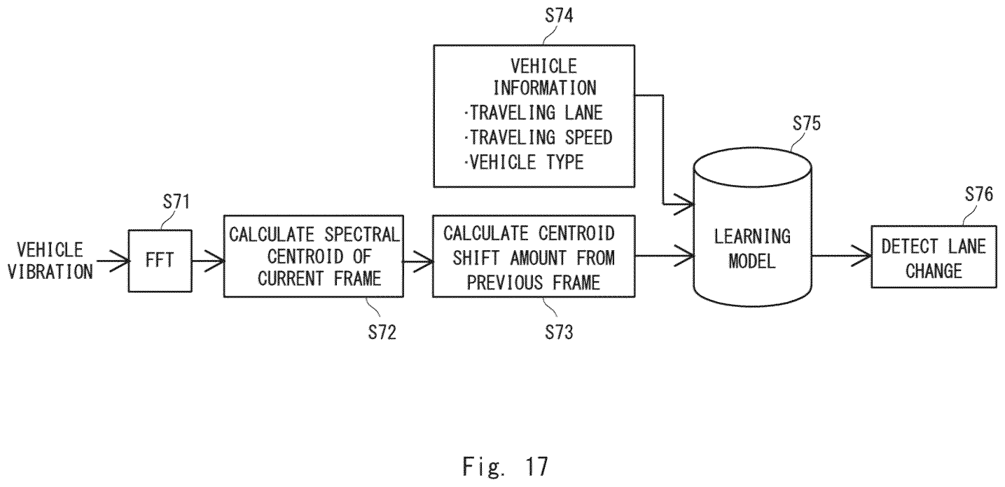

Next, with reference to FIG. 17, an operation example in a case where the spectral centroid of the frequency spectrum is utilized as a specific feature in the current frame of the vehicle vibration is described, similarly to the fourth example embodiment described above.

When the vehicle vibration data of the vehicle traveling on the road R is acquired from the sensing apparatus 30 by the acquisition unit 11, the detection unit 12D performs FFT on the current frame-portion of the vehicle vibration of the vehicle (step S71), and calculates the spectral centroid of the frequency spectrum in the current frame of the vehicle vibration (step S72). Further, the detection unit 12D calculates a centroid shift amount, which is a difference between the spectral centroid of the current frame of the vehicle vibration and the spectral centroid of the previous frame of the vehicle vibration, and inputs the calculated centroid shift amount to the learning model 120 (step S73).

Further, the detection unit 12D inputs, to the learning model 120, the traveling lane, the traveling speed, and the vehicle type as the vehicle information relating to the vehicle at the time of the previous frame of the vehicle vibration (step S74).

Then, the learning model 120 outputs, for example, a probability that a lane change of the vehicle has occurred, or the like (step S75). Therefore, the detection unit 12D detects whether there is a lane change of the vehicle, based on the output of the learning model 120 (step S76).

As described above, according to the fifth example embodiment, the detection unit 12D includes the learning model 120 that is trained, with the feature amount when the lane change of the vehicle occurs, in advance. The detection unit 12D inputs, to the learning model 120, a feature amount including at least a specific feature in the current frame of the vehicle vibration of the vehicle and a traveling lane in which the vehicle was traveling in the previous frame of the vehicle vibration. Then, the detection unit 12D detects whether there is a lane change of the vehicle, based on the output of the learning model 120. Accordingly, it is possible to detect a lane change of the vehicle traveling on the road R. Other effects are similar to those of the first example embodiment described above.

### Sixth Example Embodiment

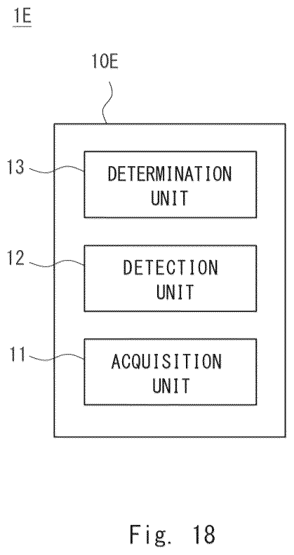

First, a schematic configuration example of a lane change detection system 1E is described with reference to FIG. 18.

The lane change detection system 1E includes a lane change detection apparatus 10E.

As compared with the lane change detection apparatus 10, the lane change detection apparatus 10E has a configuration in which a determination unit 13 is added.

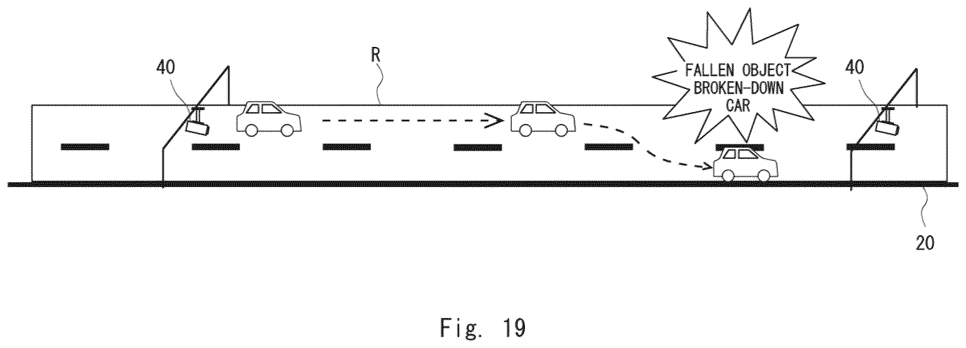

Herein, with reference to FIG. 19, a case where a fallen object or a broken-down vehicle is present on a road R is considered. Herein, the fallen object or the broken-down vehicle is present in a second lane being farther from the optical fiber 20. In such a case, it is considered that, upon noticing the presence of the fallen object or the broken-down vehicle, a vehicle traveling in the second lane changes the lane to a first lane in order to avoid the fallen object or the broken-down vehicle.

Therefore, at a position where the fallen object or the broken-down vehicle is present on the road R, it is considered that many vehicles change lanes.

Therefore, the determination unit 13 determines the position where the lane change frequently occurs as an abnormality occurrence position, such as a position where a fallen object or a broken-down vehicle is present.

Specifically, when the detection unit 12 determines that the lane change of the vehicle has occurred, the determination unit 13 first determines the position at which the lane change of the vehicle on the road R has occurred. Herein, the determination unit 13 determines the position (the distance of the optical fiber 20 from the sensing apparatus 30) where the vehicle vibration, the data of which are acquired by the acquisition unit 11, is generated as the position where the lane change has occurred.

Next, the determination unit 13 determines whether a lane change has occurred at the position determined above a predetermined number of times or more. When the lane change has occurred a predetermined number of times or more at the position determined above, the determination unit 13 determines the position determined above as an abnormality occurrence position such as a position where a fallen object or a broken-down vehicle is present.

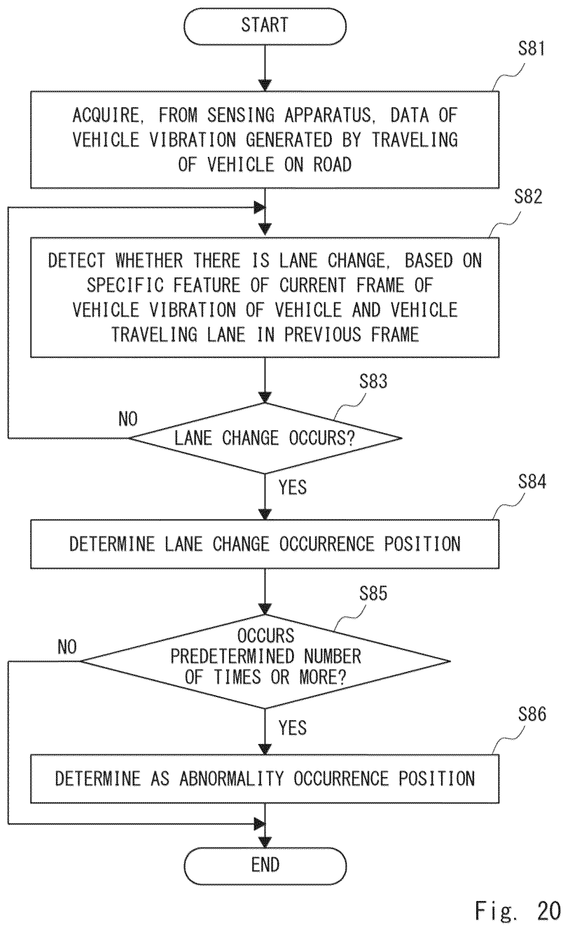

Next, a schematic operation example of the lane change detection system 1E is described with reference to FIG. 20.

First, the processing of steps S81 to S83 similar to steps S11 to S13 in FIG. 5 is performed.

In step S83, when the detection unit 12 determines that the lane change of the vehicle has occurred (YES in step S83), the determination unit 13 determines the position where the lane change of the vehicle on the road R has occurred (step S84).

Next, the determination unit 13 determines whether a lane change has occurred at the position determined in step S84 for a predetermined number of times or more (step S85).

When it is determined that the lane change has occurred a predetermined number of times or more at the position determined in step S84 (YES in step S85), the determination unit 13 determines the position determined in step S84 as the abnormality occurrence position (step S86). Meanwhile, when it is determined that the lane change has not occurred a predetermined number of times or more at the position determined in step S84 (NO in step S85), the determination unit 13 ends the processing.

As described above, according to the sixth example embodiment, when the detection unit 12 determines that the lane change of the vehicle has occurred, the determination unit 13 determines the position at which the lane change of the vehicle has occurred on the road R, and in a case where the lane change has occurred a predetermined number of times or more at the position, determines the position as the abnormality occurrence position. As a result, it is possible to determine an abnormality occurrence position such as a position where a fallen object or a broken-down vehicle is present. Other effects are similar to those of the first example embodiment described above.

Note that, in the sixth example embodiment, the number of times the lane change has occurred is used as a parameter for determining whether the lane change has occurred frequently, but the present disclosure is not limited thereto. As the above-described parameters, other parameters may be used, such as the number of times the lane change has occurred per unit time, the ratio of the lane-changed vehicles among the vehicles traveling in the relevant lane, and the like.

In the sixth example embodiment, although the lane change detection apparatus 10E is provided with the detection unit 12, any one of the detection units 12A, 12B, 12C, and 12D may be provided thereto instead of the detection unit 12.

### Other Example Embodiments

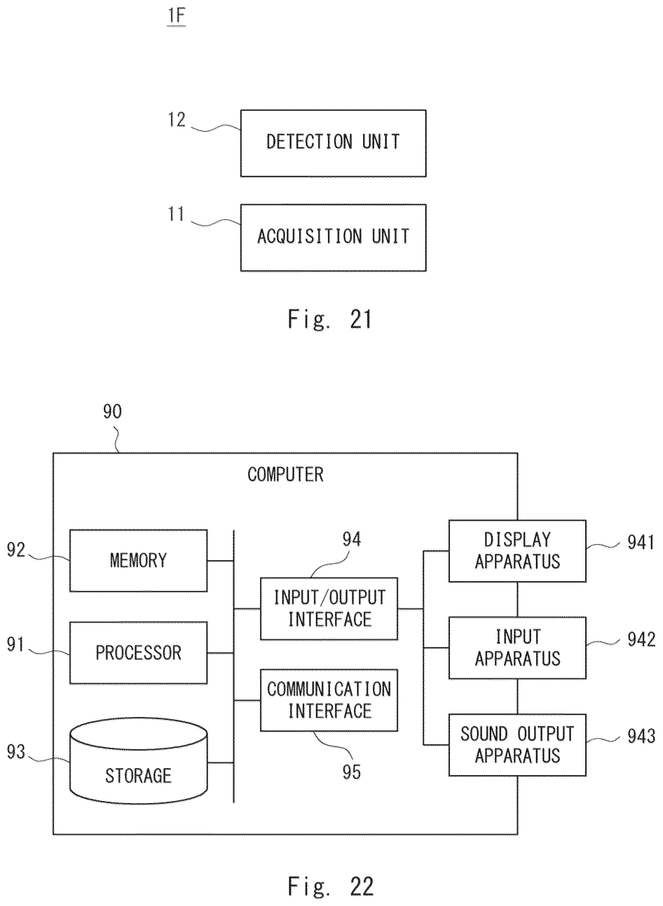

In the first to sixth example embodiments described above, the acquisition unit 11, the detection units 12, 12A, 12B, 12C, and 12D, and the determination unit 13 are provided inside the lane change detection apparatuses 10, 10A, 10B, 10C, 10D, and 10E, but the present disclosure is not limited thereto. The acquisition unit 11, the detection units 12, 12A, 12B, 12C, and 12D, and the determination unit 13 may be provided in different apparatuses or may be provided on a cloud. FIG. 21 illustrates a configuration example of a lane change detection system IF in which an acquisition unit 11 and a detection unit 12 are provided on different apparatuses or provided on a cloud. In the lane change detection system 1F illustrated in FIG. 21, instead of the detection unit 12, any one of the detection units 12A, 12B, 12C, and 12D may be provided, and the determination unit 13 may be additionally provided.

In the first to sixth example embodiments described above, the road R having two lanes has been described as an example, but the road R may be a road having three or more lanes. For a road R having three or more lanes, for example, in the steps S22, S33, and S44 in the above-described FIGS. 7, 10, and 13, branching may be added for each lane.

### <Hardware Configuration of Lane Change Detection Apparatus According to Example Embodiments>

Next, a hardware configuration example of a computer 90 that implements the above-described lane change detection apparatuses 10, 10A, 10B, 10C, 10D, and 10E is described with reference to FIG. 22.

As illustrated in FIG. 22, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for transmitting and receiving data to and from one another.

The processor 91 is, for example, an arithmetic processing apparatus such as a central processing unit (CPU) or a graphics processing unit (GPU). The memory 92 is, for example, a memory such as a random access memory (RAM) or a read only memory (ROM). The storage 93 is, for example, a storage apparatus such as a hard disk drive (HDD), a solid state drive (SSD), or a memory card. The storage 93 may be a memory such as a RAM or a ROM.

A program is stored in the storage 93. The program includes instructions (or software code) for causing the computer 90 to perform one or more functions of the lane change detection apparatuses 10, 10A, 10B, 10C, 10D, and 10E described above when loaded into the computer. The above-described components of the lane change detection apparatuses 10, 10A, 10B, 10C, 10D, and 10E may be implemented by the processor 91 reading and executing the program stored in the storage 93. Further, the above-described storage functions of the lane change detection apparatuses 10, 10A, 10B, 10C, 10D, and 10E may be implemented by the memory 92 or the storage 93.

Further, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display apparatus 941, an input apparatus 942, a sound output apparatus 943, and the like. The display apparatus 941 is an apparatus such as a liquid crystal display (LCD), a cathode ray tube (CRT) display, or a monitor that displays a screen associated with rendering data processed by the processor 91. The input apparatus 942 is an apparatus that receives an operation input from an operator, and is, for example, a keyboard, a mouse, a touch sensor, or the like. The display apparatus 941 and the input apparatus 942 may be integrated and implemented as a touch panel. The sound output apparatus 943 is an apparatus, such as a speaker, that outputs sound associated with the sound data processed by the processor 91.

The communication interface 95 transmits and receives data to and from an external apparatus. For example, the communication interface 95 communicates with an external apparatus via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A lane change detection apparatus including:
at least one memory storing instructions; and
at least one processor configured to execute the instructions to
   acquire, from a sensing apparatus configured to measure vibration generated on a road by using an optical fiber embedded in the road, vehicle vibration data indicating vibration generated by traveling of a vehicle on the road, and
   detect whether there is a lane change of the vehicle, based on a specific feature in a current frame of the vehicle vibration, and a traveling lane in which the vehicle has traveled in a previous frame of the vehicle vibration.

### (Supplementary Note 2)

The lane change detection apparatus according to supplementary note 1, wherein the at least one processor is further configured to:
calculate average vibration intensity as a specific feature in a current frame of the vehicle vibration; and
detect whether there is a lane change of the vehicle, based on a traveling lane in which the vehicle has traveled in a previous frame of the vehicle vibration and a comparison result between the average vibration intensity in the current frame of the vehicle vibration and a threshold value.

### (Supplementary Note 3)

The lane change detection apparatus according to supplementary note 1, wherein the at least one processor is further configured to:
calculate average vibration intensity of a specific frequency band as a specific feature in a current frame of the vehicle vibration; and
detect whether there is a lane change of the vehicle, based on a traveling lane in which the vehicle has traveled in a previous frame of the vehicle vibration and a comparison result between the average vibration intensity of the specific frequency band in the current frame of the vehicle vibration and a threshold value.

### (Supplementary Note 4)

The lane change detection apparatus according to supplementary note 3, wherein the specific frequency band is a band in which a difference between average vibration intensity of the vehicle vibration before a lane change of the vehicle and average vibration intensity of the vehicle vibration after the lane change of the vehicle is equal to or greater than a predetermined value.

### (Supplementary Note 5)

The lane change detection apparatus according to supplementary note 1, wherein the at least one processor is further configured to:
calculate a spectral centroid of a frequency spectrum as a specific feature in a current frame of the vehicle vibration;
calculate a centroid shift amount being a difference between a spectral centroid of the current frame of the vehicle vibration and a spectral centroid of a previous frame of the vehicle vibration; and
detect whether there is a lane change of the vehicle, based on a traveling lane in which the vehicle has traveled in the previous frame of the vehicle vibration and a comparison result between the centroid shift amount in the current frame of the vehicle vibration and a threshold value.

### (Supplementary Note 6)

The lane change detection apparatus according to supplementary note 1, further including a learning model being trained, with a feature amount when the lane change of the vehicle occurs, in advance,
wherein the at least one processor is further configured to:
   input, to the learning model, the specific feature in the current frame of the vehicle vibration and the traveling lane in which the vehicle has traveled in the previous frame of the vehicle vibration as a feature amount; and
   detect whether there is a lane change of the vehicle, based on an output of the learning model.

### (Supplementary Note 7)

The lane change detection apparatus according to supplementary note 1, wherein the at least one processor is further configured to determine, when it is determined that a lane change of the vehicle occurs, a position where the lane change of the vehicle occurs on the road, and in a case where a lane change occurs a predetermined number of times or more at the position, determine the position as an abnormality occurrence position.

### (Supplementary Note 8)

A lane change detection method to be performed by a lane change detection apparatus, the lane change detection method including:
acquiring, from a sensing apparatus configured to measure vibration generated on a road by using an optical fiber embedded in the road, vehicle vibration data indicating vibration generated by traveling of a vehicle on the road; and
detecting whether there is a lane change of the vehicle, based on a specific feature in a current frame of the vehicle vibration, and a traveling lane in which the vehicle has traveled in a previous frame of the vehicle vibration.

### (Supplementary Note 9)

A non-transitory computer-readable medium storing a program causing a computer to execute:
a procedure of acquiring, from a sensing apparatus configured to measure vibration generated on a road by using an optical fiber embedded in the road, vehicle vibration data indicating vibration generated by traveling of a vehicle on the road; and
a procedure of detecting whether there is a lane change of the vehicle, based on a specific feature in a current frame of the vehicle vibration, and a traveling lane in which the vehicle has traveled in a previous frame of the vehicle vibration.

### (Supplementary Note 10)

A lane change detection system including:
at least one memory storing instructions; and
at least one processor configured to execute the instructions to
   acquire, from a sensing apparatus configured to measure vibration generated on a road by using an optical fiber embedded in the road, vehicle vibration data indicating vibration generated by traveling of a vehicle on the road, and
   detect whether there is a lane change of the vehicle, based on a specific feature in a current frame of the vehicle vibration, and a traveling lane in which the vehicle has traveled in a previous frame of the vehicle vibration.

Note that, some or all of elements (e.g., structures and functions) specified in Supplementary Notes 2 to 7 dependent on Supplementary Note 1 may also be dependent on Supplementary Note 8, Supplementary Note 9 and Supplementary Note 10 in dependency similar to that of Supplementary Notes 2 to 7 dependent on Supplementary Note 1. Some or all of elements specified in any of Supplementary Notes may be applied to various types of hardware, software, and recording means for recording software, systems, and methods.

What is claimed is:

1. A lane change detection apparatus comprising:
at least one memory storing instructions; and
at least one processor configured to execute the instructions to
acquire, from a sensing apparatus configured to measure vibration generated on a road by using an optical fiber embedded in the road, vehicle vibration data indicating vibration generated by traveling of a vehicle on the road, and
detect whether there is a lane change of the vehicle, based on a specific feature in a current frame of the vehicle vibration, and a traveling lane in which the vehicle has traveled in a previous frame of the vehicle vibration.

2. The lane change detection apparatus according to claim 1, wherein the at least one processor is further configured to:
calculate average vibration intensity as a specific feature in a current frame of the vehicle vibration; and
detect whether there is a lane change of the vehicle, based on a traveling lane in which the vehicle has traveled in a previous frame of the vehicle vibration and a comparison result between the average vibration intensity in the current frame of the vehicle vibration and a threshold value.

3. The lane change detection apparatus according to claim 1, wherein the at least one processor is further configured to:
calculate average vibration intensity of a specific frequency band as a specific feature in a current frame of the vehicle vibration; and
detect whether there is a lane change of the vehicle, based on a traveling lane in which the vehicle has traveled in a previous frame of the vehicle vibration and a comparison result between the average vibration intensity of the specific frequency band in the current frame of the vehicle vibration and a threshold value.

4. The lane change detection apparatus according to claim 3, wherein the specific frequency band is a band in which a difference between average vibration intensity of the vehicle vibration before a lane change of the vehicle and average vibration intensity of the vehicle vibration after the lane change of the vehicle is equal to or greater than a predetermined value.

5. The lane change detection apparatus according to claim 1, wherein the at least one processor is further configured to:
calculate a spectral centroid of a frequency spectrum as a specific feature in a current frame of the vehicle vibration;
calculate a centroid shift amount being a difference between a spectral centroid of the current frame of the vehicle vibration and a spectral centroid of a previous frame of the vehicle vibration; and
detect whether there is a lane change of the vehicle, based on a traveling lane in which the vehicle has traveled in the previous frame of the vehicle vibration and a comparison result between the centroid shift amount in the current frame of the vehicle vibration and a threshold value.

6. The lane change detection apparatus according to claim 1, further comprising a learning model being trained, with a feature amount when the lane change of the vehicle occurs, in advance,
wherein the at least one processor is further configured to:
input, to the learning model, the specific feature in the current frame of the vehicle vibration and the traveling lane in which the vehicle has traveled in the previous frame of the vehicle vibration as a feature amount; and
detect whether there is a lane change of the vehicle, based on an output of the learning model.

7. The lane change detection apparatus according to claim 1, wherein the at least one processor is further configured to determine, when it is determined that a lane change of the vehicle occurs, a position where the lane change of the vehicle occurs on the road, and in a case where a lane change occurs a predetermined number of times or more at the position, determine the position as an abnormality occurrence position.

8. A lane change detection method to be performed by a lane change detection apparatus, the lane change detection method comprising:
acquiring, from a sensing apparatus configured to measure vibration generated on a road by using an optical fiber embedded in the road, vehicle vibration data indicating vibration generated by traveling of a vehicle on the road; and
detecting whether there is a lane change of the vehicle, based on a specific feature in a current frame of the vehicle vibration, and a traveling lane in which the vehicle has traveled in a previous frame of the vehicle vibration.

9. A non-transitory computer-readable medium storing a program causing a computer to execute:
a procedure of acquiring, from a sensing apparatus configured to measure vibration generated on a road by using an optical fiber embedded in the road, vehicle vibration data indicating vibration generated by traveling of a vehicle on the road; and
a procedure of detecting whether there is a lane change of the vehicle, based on a specific feature in a current frame of the vehicle vibration, and a traveling lane in which the vehicle has traveled in a previous frame of the vehicle vibration.
